(19) United States
(12) Patent Application Publication
(10) Pub. No.: US 2015/0363801 A1
(43) Pub. Date: Dec. 17, 2015

(54) APPARATUS AND METHOD FOR PREDICTING THE BEHAVIOR OR STATE OF A NEGATIVE OCCURRENCE CLASS

(71) Applicant: BOTTOMLINE TECHNOLOGIES (DE) INC., Portsmouth, NH (US)

(72) Inventors: Fred Ramberg, North Hampton, NH (US); Jerzy Bala, Potomac Falls, VA (US)

(21) Appl. No.: 14/305,246

(22) Filed: Jun. 16, 2014

(51) Int. Cl. G06Q 30/02

(52) U.S. Cl. CPC G06Q 30/0202

(57) ABSTRACT

A method and apparatus are presented for predicting the behavior or state of a negative occurrence class by scoring histories of members of the negative occurrence class against pasts of members of a positive occurrence class. The method and apparatus predicts the members of the negative occurrence class that are most likely to next transition to members of the positive occurrence class.

### TECHNICAL FIELD

The present invention relates to a data processing method and apparatus, more particularly, to a method and apparatus for predicting a next group of members to transition to another class.

### BACKGROUND OF THE INVENTION

Businesses frequently use predictive analysis to predict the behavior of their customers, markets (e.g., stock prices), etc. Current predictive analysis techniques typically use regression and classification approaches to predict the likelihood of, e.g., a user taking some action. For example, a newspaper may analyze their subscribers in order to estimate the likelihood that a given user will unsubscribe.

### SUMMARY OF THE INVENTION

While current predictive analysis techniques are capable of predicting the likelihood of an event occurring in the future, these techniques are unable to predict when the event will occur in the future. For example, a newspaper may determine the users most likely to unsubscribe using current techniques, but the newspaper is unable to tell which users are most likely to unsubscribe today or tomorrow. This creates a problem if the newspaper wants to take action to entice users to remain subscribers, because the users determined as most likely to unsubscribe by current techniques may not be likely to unsubscribe for many years. That is, the newspapers may waste resources by giving promotions to subscribers that are not likely to unsubscribe for many years, while neglecting those users that are most likely to unsubscribe today or tomorrow. For this reason, predictive analysis techniques are needed that are capable of predicting the users most likely to unsubscribe in the near future.

The present disclosure provides a method and apparatus for predicting the behavior or state of a negative occurrence class (i.e., the other class to the class from which predictive model is to be generated) by scoring histories of members of the negative occurrence class against pasts of members of a positive occurrence class. The method and apparatus predict the members of the negative occurrence class that are most likely to next transition to members of the positive occurrence class.

According to one aspect of the disclosure, there is provided a method for predicting the behavior or state of a negative occurrence class by scoring histories of members of the negative occurrence class against pasts of members of a positive occurrence class. The method includes identifying the positive occurrence class, where each of the members of the positive occurrence class were previously members of the negative occurrence class. The method also includes determining positive occurrence class rules defining at least one cluster of the members of the positive occurrence class. The positive occurrence class rules are based on the pasts of the members of the is positive occurrence class. The pasts of the members of the positive occurrence class include properties of the members of the positive occurrence class prior to becoming members of the positive occurrence class. The method also includes determining a center of each of the at least one cluster of the members of the positive occurrence class and identifying the negative occurrence class. Each of the members of the negative occurrence class are currently members of the negative occurrence class. The method also includes determining negative occurrence class rules defining at least one cluster of the members of the negative occurrence class. The negative occurrence class rules are based on the pasts of the members of the negative occurrence class. The histories of the members of the negative occurrence class includes properties of the members of the negative occurrence class. The method also includes determining a center of each of the at least one cluster of the members of the negative occurrence class and determining a nearest cluster distance for each cluster of the members of the negative occurrence class, wherein the nearest cluster distance is the distance between the center of a given cluster of the members of the negative occurrence class to the center of the nearest cluster of the members of the positive occurrence class. The method also includes identifying the cluster of the members of the negative occurrence class having the smallest nearest cluster distance as the cluster of the members of the negative occurrence class that are most likely to next transition to members of the positive occurrence class.

Alternatively or additionally, the pasts of the members of the positive occurrence class only includes properties of the members of the positive occurrence class prior to becoming a member of the positive occurrence class.

Alternatively or additionally, the method also includes rank ordering the at least one clusters of the members of the negative occurrence class in order of the nearest cluster distance. Clusters having a smaller nearest cluster distance are more likely to next transition to the positive occurrence class.

Alternatively or additionally, in each of the at least one cluster of the members of the negative occurrence class, the members in a select cluster of the negative is occurrence class are rank ordered as more likely to transition next to the positive occurrence class based on the distance of each of the members in the select cluster to the center of the select cluster and members in the select cluster closer to the center of the select cluster are more likely to next transition to the positive occurrence class.

Alternatively or additionally, in determining the nearest cluster distance, the nearest cluster of the members of the positive occurrence class is the cluster having a smallest weighted distance between the center of the given cluster of the members of the negative occurrence class to the center of the nearest cluster of the members of the positive occurrence class.

Alternatively or additionally, a weighted distance is determined by weighting the distance between the center of a given cluster of the members of the negative occurrence class to the center of a given cluster of the members of the positive occurrence class by a weight applied to at least one of the given cluster of the members of the positive occurrence class or the given cluster of the members of the negative occurrence class.

Alternatively or additionally, the weight applied to at least one of the given cluster of the members of the positive occurrence class or the given cluster of the members of the negative occurrence class is based on at least one of the number of members of or the density of the given cluster of the positive occurrence class and/or the given cluster of the negative occurrence class.

Alternatively or additionally, the members of the negative occurrence class are users that are subscribers and members of the positive occurrence class are users that were previously subscribers that have unsubscribed.

Alternatively or additionally, the members of the negative occurrence class are current subscribers to an electronic payment processing service.

Alternatively or additionally, cluster analysis is used to determine the positive occurrence class rules and the negative occurrence class rules.

Alternatively or additionally, determining the negative occurrence class rules and/or the positive occurrence class rules are performed using connectivity models, centroid models, distribution models, density models, subspace models, group models, or graph-based models.

Alternatively or additionally, the pasts of the members of the positive class and the histories of the members of the negative class include at least one of time duration as a member, received member complaints, business size, or fees paid by the member.

Alternatively or additionally, the method further includes identifying at least one remedial measure predicted to reduce the likelihood of members of the negative occurrence class having the smallest nearest cluster distance from transitioning to members of the positive occurrence class.

The present disclosure additionally provides an apparatus for predicting the behavior of a negative occurrence class by scoring histories of members of the negative occurrence class against pasts of members of a positive occurrence class. The apparatus includes a database stored on a non-transitory computer readable medium, wherein the database includes data regarding the members of the positive occurrence class and data regarding the members of the negative occurrence class. The apparatus also includes a processor configured to receive an identification of the positive occurrence class. The members of the positive occurrence class were previously members of the negative occurrence class and determine positive occurrence class rules defining at least one cluster of the members of the positive occurrence class. The positive occurrence class rules are based on the pasts of the members of the positive occurrence class. The pasts of the members of the positive occurrence class includes properties of the members of the positive occurrence class prior to becoming a member of the positive occurrence class. The processor is also configured to determine a center of each of the at least one cluster of the members of the positive occurrence class and receive an identification of the negative occurrence class. Each of the members of the negative occurrence class are currently members of the negative occurrence class. The processor is also configured to determine negative occurrence class rules defining at least one cluster of the members of the negative occurrence class. The negative occurrence class rules are based on the pasts of the members of the negative is occurrence class. The histories of the members of the negative occurrence class includes properties of the members of the negative occurrence class. The processor is also configured to determine a center of each of the at least one clusters of the members of the negative occurrence class. The processor is also configured to determine a nearest cluster distance for each cluster of the members of the negative occurrence class. The nearest cluster distance is the distance between the center of a given cluster of the members of the negative occurrence class to the center of the nearest cluster of the members of the positive occurrence class. The processor is also configured to identify the cluster of the members of the negative occurrence class having the smallest nearest cluster distance as the cluster of the members of the negative occurrence class that is most likely to next transition to the positive occurrence class.

Alternatively or additionally, the pasts of the members of the positive occurrence class stored in the database only includes properties of the members of the positive occurrence class prior to becoming a member of the positive occurrence class.

Alternatively or additionally, the processor is further configured to rank order the at least one clusters of the members of the negative occurrence class in order of the nearest cluster distance, wherein clusters having a smaller nearest cluster distance are more likely to next transition to the positive occurrence class.

Alternatively or additionally, in determining the nearest cluster distance, the nearest cluster of the members of the positive occurrence class is the cluster having a smallest weighted distance between the center of the given cluster of the members of the negative occurrence class to the center of the nearest cluster of the members of the positive occurrence class.

Alternatively or additionally, a weighted distance is determined by weighting the distance between the center of a given cluster of the members of the negative occurrence class to the center of a given cluster of the members of the positive occurrence class by a weight applied to at least one of the given cluster of the members of the positive occurrence class or the given cluster of the members of the negative is occurrence class.

Alternatively or additionally, the weight applied to at least one of the given cluster of the members of the positive occurrence class or the given cluster of the members of the negative occurrence class is based on at least one of the number of members of or the density of the given cluster of the positive occurrence class and/or the given cluster of the negative occurrence class.

Alternatively or additionally, in each of the at least one cluster of the members of the negative occurrence class, the processor is further configured to rank order the members in a select cluster of the negative occurrence class as more likely to transition next to the positive occurrence class based on the distance of each of the members in the select cluster to the center of the select cluster. Members in the select cluster closer to the center of the select cluster are more likely to next transition to the positive occurrence class.

Alternatively or additionally, the members of the negative occurrence class are users that are subscribers and members of the positive occurrence class are users that were previously subscribers that have unsubscribed.

Alternatively or additionally, the members of the negative occurrence class are current subscribers to an electronic payment processing service.

Alternatively or additionally, the processor is further configured to perform cluster analysis to determine the positive occurrence class rules and the negative occurrence class rules.

Alternatively or additionally, the processor is further configured to determine the negative occurrence class rules and/or the positive occurrence class rules using connectivity models, centroid models, distribution models, density models, subspace models, group models, or graph-based models.

Alternatively or additionally, the pasts of the members of the positive class and the histories of the members of the negative class include at least one of time duration as a member, received member complaints, business size, or fees paid by the member.

Alternatively or additionally, the processor further configured to identify at least is one remedial measure predicted to reduce the likelihood of members of the negative occurrence class having the smallest nearest cluster distance from transitioning to members of the positive occurrence class.

A number of features are described herein with respect to embodiments of this disclosure. Features described with respect to a given embodiment also may be employed in connection with other embodiments.

For a better understanding of the present disclosure, together with other and further aspects thereof, reference is made to the following description, taken in conjunction with the accompanying drawings. The scope of the disclosure is set forth in the appended claims, which set forth in detail certain illustrative embodiments. These embodiments are indicative, however, of but a few of the various ways in which the principles of the disclosure may be employed.

### BRIEF DESCRIPTION OF THE DRAWINGS

FIG. 1 is a block diagram representing the architecture of a predicting apparatus and system.

FIGS. 2A and 2B are scatter plots of feature vectors for a number of class members that have been grouped into clusters.

FIG. 2C is a scatter plot of the center of the cluster groups from FIGS. 2A and 2B.

FIG. 3 is a flow diagram representing operation of a predictive analysis method.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be appreciated that many of the elements discussed in this specification may be implemented in a hardware circuit(s), a processor executing software code or instructions which are encoded within computer readable media accessible to the processor, or a combination of a hardware circuit(s) and a processor or control block of an integrated circuit executing machine readable code encoded within a computer readable media. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a computer readable media, or a combination of a hardware circuit(s) and a processor and/or control block executing such code.

The present disclosure provides a method and apparatus for predicting the behavior or state of a negative occurrence class. The behavior or state being predicted is the likelihood or probability of members of the negative occurrence class transitioning to a positive occurrence class. In particular, the method and apparatus predict the members of the negative occurrence class that are most likely to be the next members to transition to the positive occurrence class. The prediction is performed by assuming that each member of the negative occurrence class transitioned at the current time point to the positive occurrence class. The likelihood of each member of the negative occurrence class transitioning at the current time point to the positive occurrence class is then determined. The behavior or state of the negative occurrence class is predicted by scoring histories of members of the negative occurrence class against pasts of members of the positive occurrence class. That is, the pasts of the current members of the negative occurrence class are compared to the histories of members of the positive occurrence class. In this way, the method and apparatus predicts the members of the negative occurrence class that are most likely to next transition to members of the positive occurrence class.

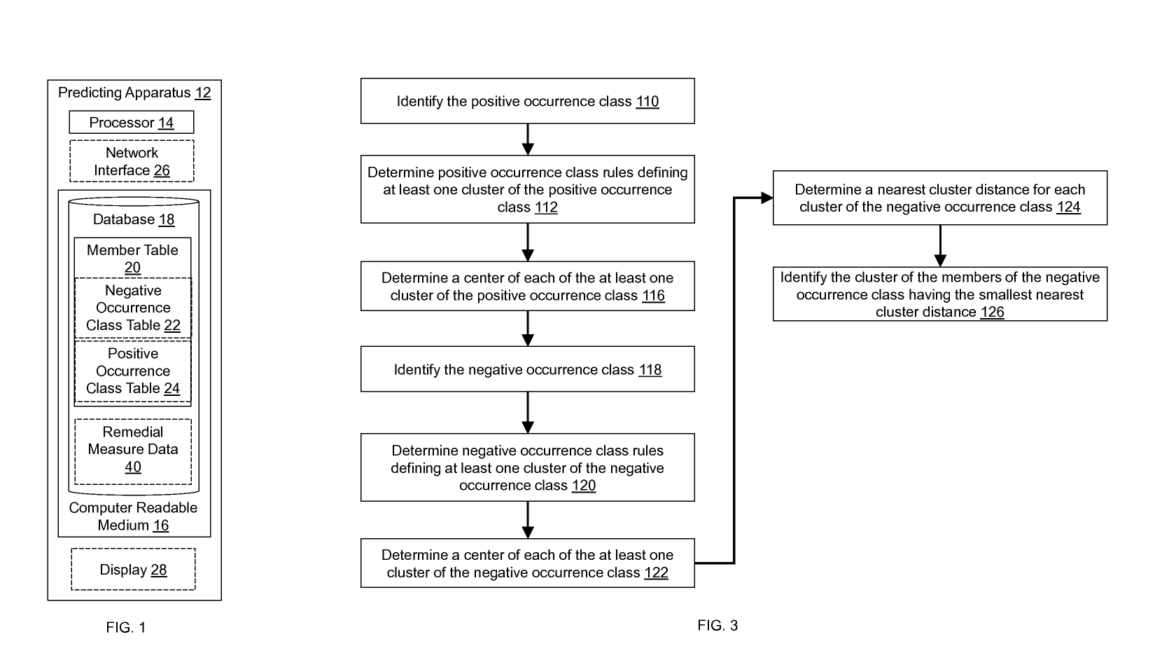

Turning to FIG. 1, an exemplary predicting apparatus 12 including a processor 14 and a computer readable medium 16 is shown. The computer readable medium 16 includes a database 18 that stores a member table 20. The member table 20 may include a negative occurrence class table 22 and a positive occurrence class table 24. The predicting apparatus 12 may additionally include a network interface 26 and a display 28.

As will be understood by one of ordinary skill in the art, the computer readable medium 16 may be, for example, one or more of a buffer, a flash memory, a hard drive, a removable media, a volatile memory, a non-volatile memory, a random access memory (RAM), or other suitable device. In a typical arrangement, the computer readable medium 16 may include a non-volatile memory for long term data storage and a volatile memory that functions as system memory for the processor 14. The computer readable medium 16 may exchange data with the processor 16 over a data bus. Accompanying control lines and an address bus between the computer readable medium 16 and the processor 14 also may be present. The computer readable medium 16 is considered a non-transitory computer readable medium.

As described above, the non-transitory computer readable medium 16 includes a member table 20 storing data regarding a positive occurrence class and a negative occurrence class, where each member of the positive occurrence class was previously a member of the negative occurrence class. The data stored in the member table 20 regarding the positive occurrence class may be referred to as pasts of the members of the positive occurrence class. The data stored in the member table 20 regarding the negative occurrence class may be referred to as histories of the members of the negative occurrence class.

The members of the negative occurrence class may be defined as those members that differ from the positive occurrence class in a defined manner. For example, the members of the negative occurrence class may have not yet taken a particular action or do not yet have a particular property, while the members of the positive occurrence class have already taken the particular action or already have the particular property. In one example, the members of the negative occurrence class may be current subscribers to an electronic payment processing service. The positive occurrence class members may be former subscribers to the electronic payment processing service that have previously unsubscribed from the service. In another example, the negative occurrence class members may be stocks that have decreased in value over the previous year and the members of the positive occurrence class may be stocks that have increased in value by 10% over the previous year.

The data stored in the member table 20 may be organized such that the data associated with each member is stored as a single entry. The pasts of the members of the positive occurrence class includes properties of the members of the positive occurrence class prior to (e.g., immediately prior to) becoming members of the positive occurrence class. That is, the pasts of the members of the positive occurrence class includes properties of the members of the positive occurrence class while they were members of the negative occurrence class. The pasts of the members of the positive occurrence class may only include properties of the members of the positive occurrence class prior to becoming a member of the positive occurrence class. The histories of the members of the negative occurrence class includes properties of the members of the negative occurrence class. The pasts of the members of the positive class and the histories of the members of the negative class include at least one of time duration as a member, complaints received from the member, date of received complaints, business size of the member, fees paid by the member, or product usage by the member. As will be understood by one of ordinary skill in the art, the data stored in the member table 20 for a given member is not limited to the provided examples, but may include any information regarding a member.

For example, the members of the negative occurrence class may be commercial banks subscribing to an electronic payment processing service and the positive occurrence class may be commercial banks that are no longer customers/subscribers to the electronic payment processing service. In this example, data stored in the member table 20 for a given commercial bank may include the number of customers the is commercial bank has, the usage of the electronic payment service by the customers (e.g., usage of ACH, wires, remote deposit), how long the commercial bank has been a subscriber/customer, etc.

The processor 14 is configured to analyze the histories of members of the negative occurrence class against pasts of members of a positive occurrence class in order to rank or score the members of the negative occurrence class that are most likely to next transition to members of the positive occurrence class. As will be understood by one of ordinary skill in the art, the processor 14 may have various implementations. For example, the processor 14 may include any suitable device, such as a programmable circuit, integrated circuit, memory and I/O circuits, an application specific integrated circuit, microcontroller, complex programmable logic device, other programmable circuits, or the like. The processor 14 may also include a non-transitory computer readable medium, such as random access memory (RAM), a read-only memory (ROM), an erasable programmable read-only memory (EPROM or Flash memory), or any other suitable medium. Instructions for performing the method described below may be stored in the non-transitory computer readable medium and executed by the processor. The processor 14 may be communicatively coupled to the computer readable medium 16 and network interface 26 through a system bus, mother board, or using any other suitable structure known in the art.

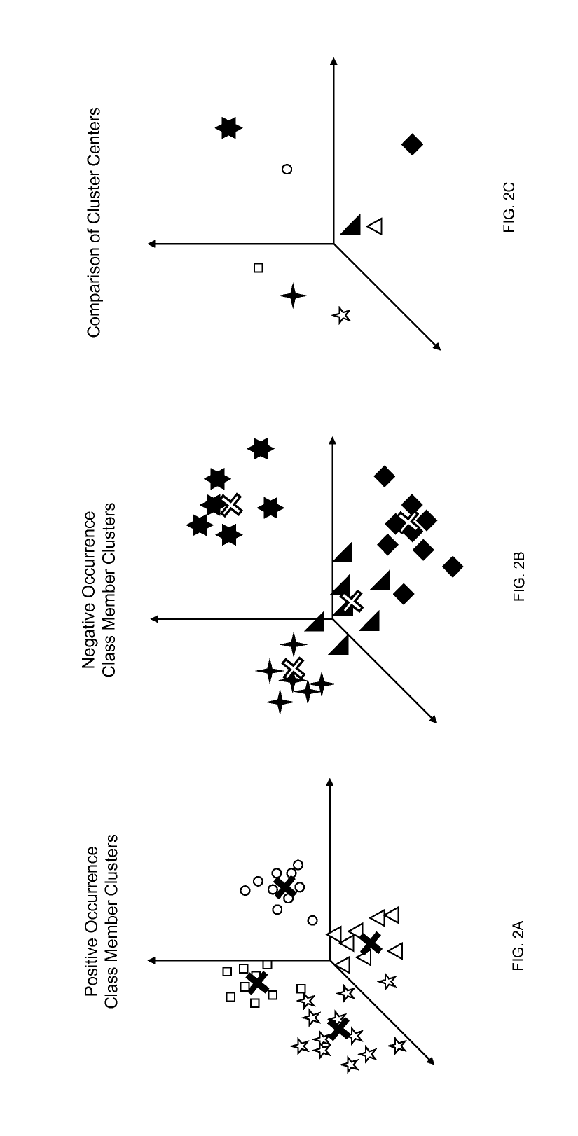

Turning to FIGS. 2A, 2B, and 3, a method for predicting the behavior or state of the negative occurrence class is described. As will be understood by one of ordinary skill in the art, the processor 14 may be configured to perform the method 100.

In processing block 110, the positive occurrence class is identified. The processor 14 is configured to analyze the data stored in the member table 20 in order to identify the members of the positive occurrence class and the members of the negative occurrence class. The processor 14 may identify positive occurrence class members and the negative occurrence class members through an identifier associated with the data for each member that labels itself as a member of the positive occurrence class or the negative occurrence class. Alternatively, the processor 14 may analyze the data for a given member in order to determine if the member has become a member of the positive occurrence class. For example, the data for a given member may be analyzed for the presence of a cancellation or un-subscription event marking the transition from the negative occurrence class to the positive occurrence class.

In processing block 112, positive occurrence class rules defining at least one cluster of the positive occurrence class are determined. The processor 14 may be configured to determine the positive occurrence class rules using any suitable method (e.g., a clustering system). For example, the processor 14 may identify a feature vector for each member of the positive occurrence class. The feature vector is based on the data stored in the member table 20 for a given member. The feature vector may include all elements of the data stored in the member table 20 or only those elements identified or suspected of being correlated with a user's propensity to transfer from the negative occurrence class to the positive occurrence class (the minimum necessary past). After a feature vector has been determined for the members of the positive occurrence class, the feature vectors are analyzed to determine rules that group the members of the positive occurrence class into at least one cluster. For example, the positive occurrence class rules may be determined using a clustering system (e.g., cluster analysis) including connectivity models, centroid models, distribution models, density models, subspace models, group models, or graph-based models. As will be understood by one of ordinary skill in the art, cluster analysis may be performed using any suitable method.

Turning to FIG. 2A, feature vectors for positive occurrence class members are shown in a multidimensional plot. While this exemplary plot includes only three dimensions, one of ordinary skill in the art will understand that the feature vectors and classification of the feature vectors may occur in more than three dimensions. In this example, each member is represented by a three-dimensional feature vector that is depicted as a single point (i.e. a star, a square, a circle, or a triangle) in the three-dimensional feature space shown in FIG. 2A. Each axis of the depicted feature space may correspond to a property of the members stored in the corresponding feature vector. The positive occurrence class members are then clustered using any suitable is method in order to determine rules for clustering the members of the positive occurrence class.

In processing block 116, a center of each of the clusters of the positive occurrence class are determined. The processor 14 may be configured to determine the center of each cluster as the geometric center of the cluster. The center of each cluster is shown in FIG. 2A as an “X”.

In processing block 118, the negative occurrence class is identified. As described regarding the positive occurrence class, the processor 14 may be configured to determine the negative occurrence class by analyzing the data stored in the member table 20. As part of identifying the negative occurrence class, the method assumes that all members of the negative occurrence class transition at the current time point to the positive occurrence class. Although the method assumes that the members of the negative occurrence class transition to the positive occurrence class, the members of the negative occurrence class are still referred to in this disclosure as members of the negative occurrence class.

In processing block 120, the negative occurrence class rules defining at least one cluster of the negative occurrence class are determined. The processor 14 may be configured to determine the negative occurrence class rules in the same manner as the positive occurrence class rules described above.

Turning to FIG. 2B, feature vectors for negative occurrence class members are shown in a multidimensional plot. While this exemplary plot includes the same number of dimensions as the positive occurrence class member plot in FIG. 2A, one of ordinary skill in the art will understand that the feature vectors associated with the members of the negative occurrence class and classification of the feature vectors associated with the members of the negative occurrence class may occur in a different number of dimensions, a different feature space, or the same feature space as the feature vectors associated with the members of the positive occurrence class. In this example, each member of the negative occurrence class is represented by a three-dimensional feature vector that is depicted as a single point (i.e. a four pointed star, a diamond, a six pointed start, or a triangle) in the three-dimensional feature space shown in FIG. 2B. Each axis of the depicted feature space may correspond to a property of the members stored in the corresponding feature vector. The negative occurrence class members are then clustered as if they are members of the positive occurrence class. The negative occurrence class members may be clustered using any suitable method in order to determine rules for clustering the members of the negative occurrence class. The negative occurrence class members may be clustered, e.g., using the same or a different method as the method used to cluster the positive occurrence class members.

In processing block 122, the center of each of the at least one clusters of the negative occurrence class are determined. The processor 14 may be configured to determine the center of each of the negative occurrence class clusters in the same manner as the positive occurrence class clusters described above. The center of each cluster in FIG. 2B is shown as an “X”.

In process block 124, the nearest cluster distance is determined for each cluster of the negative occurrence class. The nearest cluster distance is the distance between the center of a given cluster of the negative occurrence class to the center of the nearest cluster of the positive occurrence class. The processor 14 may be configured to determine the nearest cluster distance as the Euclidian distance between two cluster centers. Turning to FIG. 2C and continuing the example shown in FIGS. 2A and 2B, the center of each cluster in the positive occurrence class (FIG. 2A) is shown as a white shape with a black outline and the center of each cluster in the negative occurrence (FIG. 2B) is shown as a solid black shape. The nearest cluster distance for each cluster of the negative class can be visualized as the distance between each solid black shape to the nearest white shape with a black outline.

The nearest cluster distance may be weighted by the size/importance of the nearest cluster of the positive occurrence class. For example, clusters of the positive occurrence class may have weights normalized by the number of members of each positive occurrence class cluster (e.g., from 1 having the least importance to 0 having the most importance). The nearest cluster distance may similarly be normalized from 1 is to 0 (i.e., 1 being the largest distance and 0 being the shortest distance). The normalized weights of the positive occurrence class cluster may be used in calculating the nearest cluster distance. In one embodiment, the distance between two clusters may be multiplied by the weight applied to the positive occurrence class cluster. For example, a positive occurrence class cluster with an insignificant number of members (“the insignificant cluster) may have the closest Euclidian distance to a negative occurrence class cluster. In this example, the weight applied to the insignificant cluster may result in another positive occurrence class cluster (“the more significant cluster”) being chosen as the positive occurrence class cluster with the nearest cluster distance. In this example, the more significant cluster may have a weight that is lower than the weight of the insignificant cluster, such that the weighted or normalized distance between the negative occurrence class cluster and the more significant cluster is less than the weighted/normalized distance between the insignificant cluster and the negative occurrence class cluster. As will be understood by one of ordinary skill in the art, the weight applied to a cluster is not limited to being between 0 and 1 and the weight is similarly not limited to higher weights signifying a lower significance.

The clusters of the positive occurrence class may have weights normalized by characteristics other than the number of members in a given positive occurrence class cluster. In one embodiment the weight applied to a given cluster may be based on a density measure of the given cluster. For example, two positive occurrence class clusters with the same number of members but having different sizes (e.g., spread over a different sized volume of the feature space) may have different contributions with the more dense cluster having a stronger weight. In another example, the clusters of the negative occurrence class may have weights normalized based on a density measure of the cluster such that less dense negative occurrence class clusters have a stronger weight than denser negative occurrence class clusters.

The nearest cluster distance may also be weighted based on the distance of the a given negative occurrence class cluster to another nearest negative occurrence class cluster. For example, a first negative occurrence class cluster and a second negative is occurrence class cluster may be equidistant from a positive occurrence class cluster. If the first negative occurrence class cluster is nearer to another negative occurrence class cluster than the second negative occurrence class cluster, then the second negative occurrence class cluster may have a smaller weighted nearest cluster distance.

In processing block 126, the cluster of the members of the negative occurrence class having the smallest nearest cluster distance is identified. The cluster of the members of the negative occurrence class represent the members of the negative occurrence class that are most likely to next transition to members of the positive occurrence class. In the example shown in FIG. 2C, the negative occurrence class cluster represented by the triangle has the smallest nearest cluster distance. Thus, the negative class members represented by the triangle are the most likely to next transition to the positive occurrence class.

The results of the method 100 may be presented on a display 28 or sent via a network interface 26. For example, the negative occurrence class with the smallest nearest cluster distance may be displayed to a user as the members most likely to attrite (e.g., unsubscribe).

The processor 14 may also be configured to rank order the at least one clusters of the members of the negative occurrence class in order of the nearest cluster distance. The clusters having a smaller nearest cluster distance are more likely to next transition to the positive occurrence class.

The processor 14 may also be configured to rank order the members in a select cluster of the negative occurrence class as more likely to transition next to the positive occurrence class based on the distance of each of the members in the select cluster to the center of the select cluster. Members in the select cluster closer to the center of the select cluster are more likely to next transition to the positive occurrence class. Rank ordering of the members in a select cluster may be repeated in each cluster of the negative occurrence class. In this way, the method 100 may determine the users within a cluster of the negative occurrence class that are most likely to attrite. This may be particularly useful for very large clusters, because a sales department may have limited resources and be forced to focus on a limited number of customers (i.e., members of the negative occurrence class) that represents only a subset of the members in the cluster that is most likely to attrite.

After the negative occurrence class most likely to transition to the positive occurrence class has been identified (“the next transition cluster”), the predicting apparatus 12 may determine at least one suggested remedial measures to perform in order to decrease the probability that the next transition cluster will transition to the positive occurrence class. For example, if a cluster of users of a payment processing service are identified as most likely to unsubscribe to the service right now (i.e., the next transition cluster), the remedial system may offer each user of the group a decrease in fees, have a customer service representative call each user of the group, increase the membership level of each user of the group (e.g., transition each member to a higher costing membership level with more perks without cost to the user), or take other similar actions designed to decrease the likelihood that the users will attrite.

The database 18 may include remedial measure data 40. The remedial measure data 40 may include data regarding multiple types of remedial measures. The types of remedial measures may include at least one of promotions, calls by customer service representatives, or upgrading a user's membership. For each type of remedial measure, the remedial measure data 40 may include properties of members that received the remedial measure before and after the particular type of remedial measure was received. Properties of the member after receiving the remedial measure may include if the member transitioned to the positive class and, if the user transitioned, when the user transitioned to the positive occurrence class after receiving the remedial measure. The remedial measures data 40 may also include data regarding members of the negative occurrence class and the positive occurrence class that did not receive a remedial measure. The data regarding members not receiving a remedial measure may include properties of the user including if and when the member transitioned to the positive class.

The processor 14 may be configured to analyze the remedial measure data 40 to determine the remedial measure(s) most likely to result in the members of the next transition cluster remaining a member of the negative occurrence class (“the best remedial measure(s)”). Upon determining the best remedial measure(s) the processor may implement the best remedial measure(s). For example, if the best remedial measures are applying a discount to a user's account and calling the user to discuss a recent problem, the processor 14 may apply a discount to the user's account and place a notification in the user's record instructing a customer service representative to call the user.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. A method for predicting the behavior or state of a negative occurrence class by scoring histories of members of the negative occurrence class against pasts of members of a positive occurrence class, the method comprising:
identifying the positive occurrence class, wherein each of the members of the positive occurrence class were previously members of the negative occurrence class;
determining positive occurrence class rules defining at least one cluster of the members of the positive occurrence class, wherein:
the positive occurrence class rules are based on the pasts of the members of the positive occurrence class; and
the pasts of the members of the positive occurrence class includes properties of the members of the positive occurrence class prior to becoming members of the positive occurrence class;
determining a center of each of the at least one cluster of the members of the positive occurrence class;
identifying the negative occurrence class, wherein each of the members of the negative occurrence class are currently members of the negative occurrence class;
determining negative occurrence class rules defining at least one cluster of the members of the negative occurrence class, wherein:
the negative occurrence class rules are based on the pasts of the members of the negative occurrence class; and
the histories of the members of the negative occurrence class includes properties of the members of the negative occurrence class;
determining a center of each of the at least one cluster of the members of the negative occurrence class;
determining a nearest cluster distance for each cluster of the members of the negative occurrence class, wherein the nearest cluster distance is the distance between the center of a given cluster of the members of the negative occurrence class to the center of the nearest cluster of the members of the positive occurrence class;
identifying the cluster of the members of the negative occurrence class having the smallest nearest cluster distance as the cluster of the members of the negative occurrence class that are most likely to next transition to members of the positive occurrence class.

2. The method of claim 1, wherein the pasts of the members of the positive occurrence class only includes properties of the members of the positive occurrence class prior to becoming a member of the positive occurrence class.

3. The method of claim 1, further comprising rank ordering the at least one clusters of the members of the negative occurrence class in order of the nearest cluster distance, wherein clusters having a smaller nearest cluster distance are more likely to next transition to the positive occurrence class.

4. The method of claim 1, wherein, in each of the at least one cluster of the members of the negative occurrence class, the members in a select cluster of the negative occurrence class are rank ordered as more likely to transition next to the positive occurrence class based on the distance of each of the members in the select cluster to the center of the select cluster and members in the select cluster closer to the center of the select cluster are more likely to next transition to the positive occurrence class.

5. The method of claim 1, wherein, in determining the nearest cluster distance, the nearest cluster of the members of the positive occurrence class is the cluster having a smallest weighted distance between the center of the given cluster of the members of the negative occurrence class to the center of the nearest cluster of the members of the positive occurrence class.

6. The method of claim 5, wherein a weighted distance is determined by weighting the distance between the center of a given cluster of the members of the negative occurrence class to the center of a given cluster of the members of the positive occurrence class by a weight applied to at least one of the given cluster of the members of the positive occurrence class or the given cluster of the members of the negative occurrence class.

7. The method of claim 6, wherein the weight applied to at least one of the given cluster of the members of the positive occurrence class or the given cluster of the members of the negative occurrence class is based on at least one of the number of members of or the density of the given cluster of the positive occurrence class and/or the given cluster of the negative occurrence class.

8. The method of claim 1, wherein the members of the negative occurrence class are users that are subscribers and members of the positive occurrence class are users that were previously subscribers that have unsubscribed.

9. The method of claim 8, wherein the members of the negative occurrence class are current subscribers to an electronic payment processing service.

10. The method of claim 1, wherein cluster analysis is used to determine the positive occurrence class rules and the negative occurrence class rules.

11. The method of claim 10, wherein determining the negative occurrence class rules and/or the positive occurrence class rules are performed using connectivity models, centroid models, distribution models, density models, subspace models, group models, or graph-based models.

12. The method of claim 1, wherein the pasts of the members of the positive class and the histories of the members of the negative class include at least one of time duration as a member, received member complaints, business size, or fees paid by the member.

13. The method of claim 1, further comprising identifying at least one remedial measure predicted to reduce the likelihood of members of the negative occurrence class having the smallest nearest cluster distance from transitioning to members of the positive occurrence class.

14. An apparatus for predicting the behavior of a negative occurrence class by scoring histories of members of the negative occurrence class against pasts of members of a positive occurrence class, the apparatus comprising:
a database stored on a non-transitory computer readable medium, wherein the database includes data regarding the members of the positive occurrence class and data regarding the members of the negative occurrence class;
a processor configured to:
receive an identification of the positive occurrence class, wherein the members of the positive occurrence class were previously members of the negative occurrence class;
determine positive occurrence class rules defining at least one cluster of the members of the positive occurrence class, wherein:
the positive occurrence class rules are based on the pasts of the members of the positive occurrence class; and
the pasts of the members of the positive occurrence class includes properties of the members of the positive occurrence class prior to becoming a member of the positive occurrence class;
determine a center of each of the at least one cluster of the members of the positive occurrence class;
receive an identification of the negative occurrence class, wherein each of the members of the negative occurrence class are currently members of the negative occurrence class;
determine negative occurrence class rules defining at least one cluster of the members of the negative occurrence class, wherein:
the negative occurrence class rules are based on the pasts of the members of the negative occurrence class; and
the histories of the members of the negative occurrence class includes properties of the members of the negative occurrence class;
determine a center of each of the at least one clusters of the members of the negative occurrence class;
determine a nearest cluster distance for each cluster of the members of the negative occurrence class, wherein the nearest cluster distance is the distance between the center of a given cluster of the members of the negative occurrence class to the center of the nearest cluster of the members of the positive occurrence class;
identify the cluster of the members of the negative occurrence class having the smallest nearest cluster distance as the cluster of the members of the negative occurrence class that is most likely to next transition to the positive occurrence class.

15. The apparatus of claim 14, wherein the pasts of the members of the positive occurrence class stored in the database only includes properties of the members of the positive occurrence class prior to becoming a member of the positive occurrence class.

16. The apparatus of claim 14, wherein the processor is further configured to rank order the at least one clusters of the members of the negative occurrence class in order of the nearest cluster distance, wherein clusters having a smaller nearest cluster distance are more likely to next transition to the positive occurrence class.

17. The apparatus of claim 14, wherein, in determining the nearest cluster distance, the nearest cluster of the members of the positive occurrence class is the cluster having a smallest weighted distance between the center of the given cluster of the members of the negative occurrence class to the center of the nearest cluster of the members of the positive occurrence class.

18. The apparatus of claim 17, wherein a weighted distance is determined by weighting the distance between the center of a given cluster of the members of the negative occurrence class to the center of a given cluster of the members of the positive occurrence class by a weight applied to at least one of the given cluster of the members of the positive occurrence class or the given cluster of the members of the negative occurrence class.

19. The apparatus of claim 18, wherein the weight applied to at least one of the given cluster of the members of the positive occurrence class or the given cluster of the members of the negative occurrence class is based on at least one of the number of members of or the density of the given cluster of the positive occurrence class and/or the given cluster of the negative occurrence class.

20. The apparatus of claim 14, wherein:
in each of the at least one cluster of the members of the negative occurrence class, the processor is further configured to rank order the members in a select cluster of the negative occurrence class as more likely to transition next to the positive occurrence class based on the distance of each of the members in the select cluster to the center of the select cluster; and
members in the select cluster closer to the center of the select cluster are more likely to next transition to the positive occurrence class.

21. The apparatus of claim 14, wherein the members of the negative occurrence class are users that are subscribers and members of the positive occurrence class are users that were previously subscribers that have unsubscribed.

22. The apparatus of claim 21, wherein the members of the negative occurrence class are current subscribers to an electronic payment processing service.

23. The apparatus of claim 14, wherein the processor is further configured to perform cluster analysis to determine the positive occurrence class rules and the negative occurrence class rules.

24. The apparatus of claim 23, wherein the processor is further configured to determine the negative occurrence class rules and/or the positive occurrence class rules using connectivity models, centroid models, distribution models, density models, subspace models, group models, or graph-based models.

25. The apparatus of claim 14, wherein the pasts of the members of the positive class and the histories of the members of the negative class include at least one of time duration as a member, received member complaints, business size, or fees paid by the member.

26. The apparatus of claim 14, wherein the processor further configured to identify at least one remedial measure predicted to reduce the likelihood of members of the negative occurrence class having the smallest nearest cluster distance from transitioning to members of the positive occurrence class.
